(19) United States
(12) Patent Application Publication
(10) Pub. No.: US 2002/0133826 A1
(43) Pub. Date: Sep. 19, 2002

(54) Video-on-demand system and content searching method for same

(75) Inventor: Hiroshi Ohyama, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/096,513

(22) Filed: Mar. 13, 2002

(30) Foreign Application Priority Data
Mar. 13, 2001 (JP) 2001-070926

(51) Int. Cl. G06F 3/00; H04N 5/445; G06F 13/00; H04N 7/173

(52) U.S. Cl. 725/87; 725/91; 725/53

(57) ABSTRACT

A video-on-demand system has a video-on-demand server 103, connected to a network 106, for storing a plurality of video content, a set-top box 102, connected to the network 106, for recalling video content stored in the video-on-demand server and viewing the recalled video content, and a TV picture receiving apparatus 101 connected to the set-top box 102, wherein the video-on-demand server 103 having content information 109 indicating characteristic of the plurality of video content stored therein, and a search server 107, connected to the network 106, for searching the content information 109 stored in the video-on-demand server 103, being provided.

### BACKGROUND OF THE INVENTION

1. Field of the Invention

The present invention relates to a video-on-demand system and content searching method therefore, and more particularly to a video-on-demand system and content searching method for searching a content by using a free keyword.

2. Related Art

FIG. 7 of the accompanying drawings shows the system configuration used in the past, in which a title was specified from a video-on-demand menu of a set-top box 102, and the specified content is received from a video-on-demand server 103, in which the specified content has been stored. However, the greater the amount of content is that is stored in the video-on-demand server, the more time is required to find a video title that the viewer wishes to view, and if the title has been forgotten, for example, it is not possible to find it on the menu screen, causing the viewer to give up in the search for the title.

Accordingly, it is an object of the present invention to improve on the above-noted drawbacks in the conventional art, by providing a novel video-on-demand system and content searching method therefore, which enables one to find a desired title by inputting a free keyword, even in the actual title of the video is not known.

Another object of the present invention is to provide a computer program provided for searching for content in a video-on-demand system.

### SUMMARY OF THE INVENTION

In order to achieve the above-noted objects, the present invention adopts the following basic technical constitution.

Specifically, the first aspect of the present invention is a video-on-demand system comprising: a video-on-demand server, connected to a network, for storing a plurality of video content, a set-top box, connected to the network, for recalling video content stored in the video-on-demand server and viewing the recalled video content, and a TV picture receiving apparatus connected to the set-top box, wherein the video-on-demand server having content information indicating characteristic of the plurality of video content stored therein, and a search server, connected to the network, for searching the content information stored in the video-on-demand server, being provided.

The second aspect of the present invention is that the content information is coded in an MPEG7 format.

The third aspect of the present invention is a content searching method in a video-on-demand system comprising: a video-on-demand server, connected to a network, for storing a plurality of video content, a set-top box, connected to the network, for recalling video content stored in the video-on-demand server and viewing the recalled video content, and a TV picture receiving apparatus connected to the set-top box, wherein the method comprising the steps of: inputting a keyword from the set-top box, indicating a characteristic of video content that an user desires to view, and sending the keyword to the search server from the set-top box, searching for the keyword included in the content information stored in the video-on-demand server based on an instruction from the search server, collecting search results from the video-on-demand server, and sending the search results from the search server to the set-top box.

The fourth aspect of the present invention is a computer program for a video-on-demand system comprising:

a video-on-demand server, connected to a network, for storing a plurality of video content, a set-top box, connected to the network, for recalling video content stored in the video-on-demand server and viewing the recalled video content, and a TV picture receiving apparatus connected to the set-top box, the computer program causing a search server to execute the following steps of: receiving a keyword from the set-top box, indicating a characteristic of video content that an user desires to view, instructing the video-on-demand server to search for the keyword included in the content information stored in the video-on-demand server, collecting search results from the video-on-demand server, and sending the search results from the search server to the set-top box.

The MPEG7 noted above is a technology for standardizing information to be added to diverse multimedia content, for the purpose of facilitating searching and classification thereof.

### BRIEF DESCRIPTION OF THE DRAWINGS

FIG. 1 is a drawing showing the configuration of a first embodiment of a video-on-demand system according to the present invention.

FIG. 2 is a drawing illustrating the operation of the present invention.

FIG. 3 is a drawing showing an example of a keyword input screen, and a screen indicating search results.

FIG. 4 is a flowchart illustrating the operation of the present invention.

FIG. 5 is a drawing showing the configuration of a second embodiment of the present invention.

FIG. 6 is a drawing showing the configuration of a third embodiment of the present invention.

FIG. 7 is a drawing showing the configuration with the conventional art.

### DETAILED DESCRIPTION OF THE PREFERRED EMBODIMENTS

Embodiments of a video-on-demand system and content searching method according to the present invention are described in detail below, with reference made to relevant accompanying drawings.

(First Embodiment)

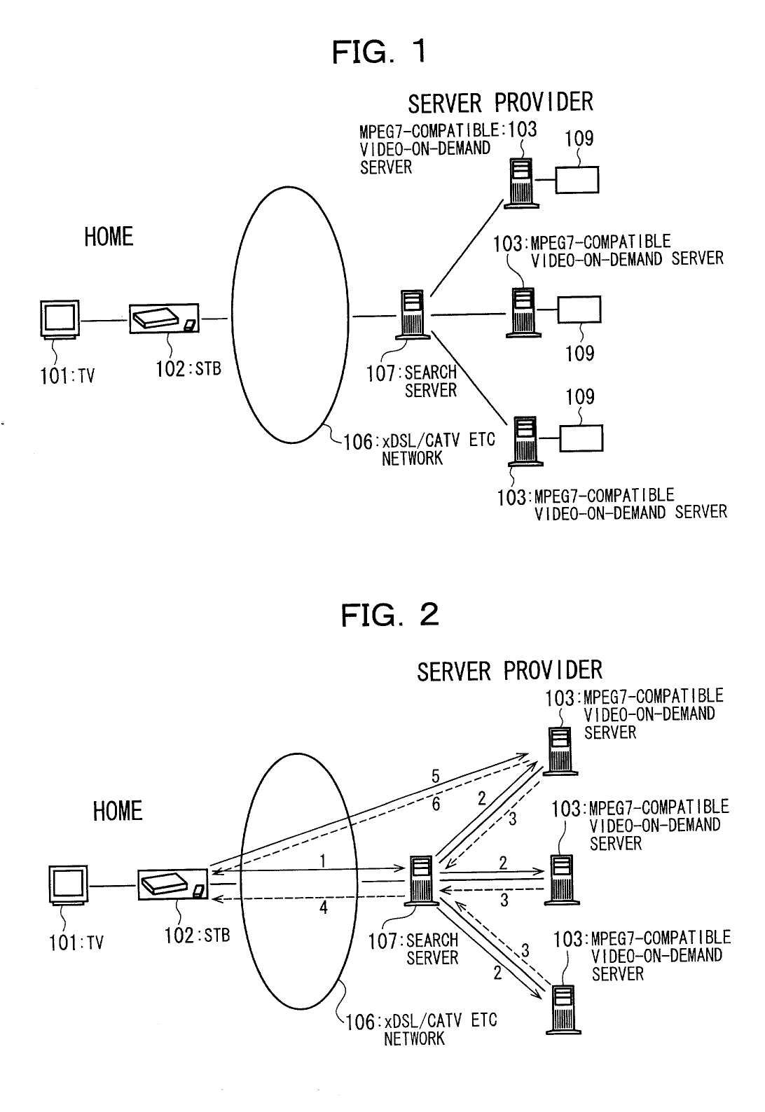

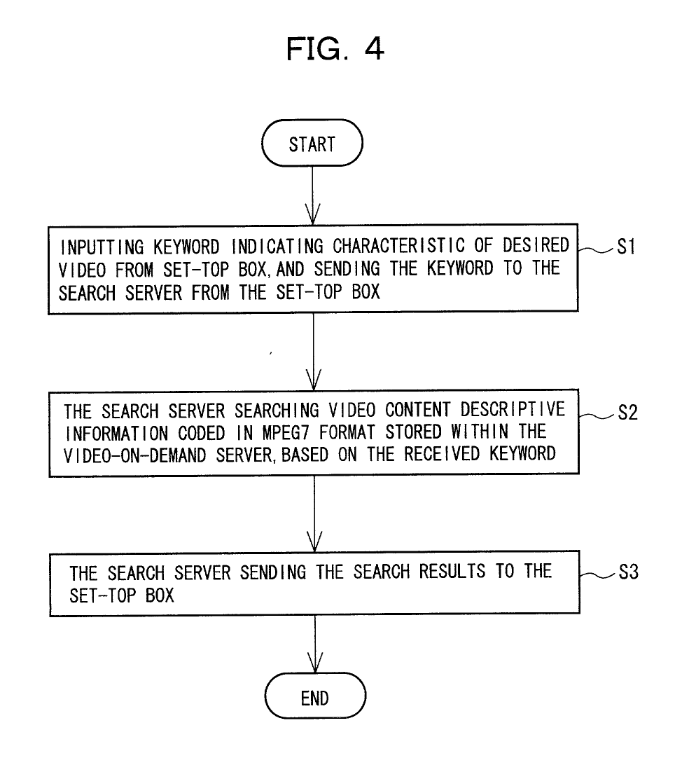

A first embodiment of a video-on-demand system according to the present invention is illustrated in FIG. 1 to FIG. 4. These drawings show a video-on-demand system comprising: a video-on-demand server 103, connected to a network 106, for storing a plurality of video content, a set-top box 102, connected to the network 106, for recalling video content stored in the video-on-demand server and viewing the recalled video content, and a TV picture receiving apparatus 101 connected to the set-top box 102, wherein the video-on-demand server 103 having content information 109 indicating characteristic of the plurality of video content stored therein, and a search server 107, connected to the network 106, for searching the content information 109 stored in the video-on-demand server 103, being provided.

The first embodiment of the present invention is described in further detail below.

First, the TV 101 is connected to the set-top box 102. The set-top box 102 is connected to an xDSL/cable TV network 106, and the search server 107 is connected to a an xDSL/cable TV network 106 and a plurality of video-on-demand (VOD) servers 103.

The TV 101 displays a picture and outputs sound based on a video signal and an audio signal sent from the set-top box 102.

The set-top box 102 decodes an MPEG1, MPEG2, or MPEG4 stream sent from the xDSL/cable TV network 106, and sends this to the TV 101. The set-top box 102 sends to the MPEG7 compatible VOD server 103 content transmission requests (for such functions as playback, stop, pause, fast forward, and rewind). A keyword is input to the set-top box 102 from a remote control unit or from a menu screen, and keyword information is sent to the search server 107 from the set-top box 102, and search results for contents matching the keyword are displayed.

The search server 107 accesses the VOD server 103 to determine whether or not there is content matching the keyword information sent from the set-top box 102. The results of this access are sent to the set-top box 102 from the VOD server 103.

The MPEG7 compatible VOD server 103 receives a content request from the set-top box 102, and sends the corresponding content to the set-top box 102. There is also a function for handling requests for trick play, such as playback, stop, pause, and fast forward, which are sent from the set-top box 102.

Each VOD server 103 stores content descriptive information (generated by MPEG7 technology) for the content at each VOD server 103, receives a request for content access from the search server 107, searches the content descriptive information to determine whether or not there is matching content at its local server, and sends the result of the search to the search server 107.

It is possible to specify the following types free keywords as keywords.

“dog” if you wish to view a video in which a dog appears.

“baseball” if you wish to view a video having a baseball scene.

“running” if you wish to view a video having running scene.

The operation of the first embodiment of the present invention is described below, with reference made to FIG. 2 to FIG. 4.

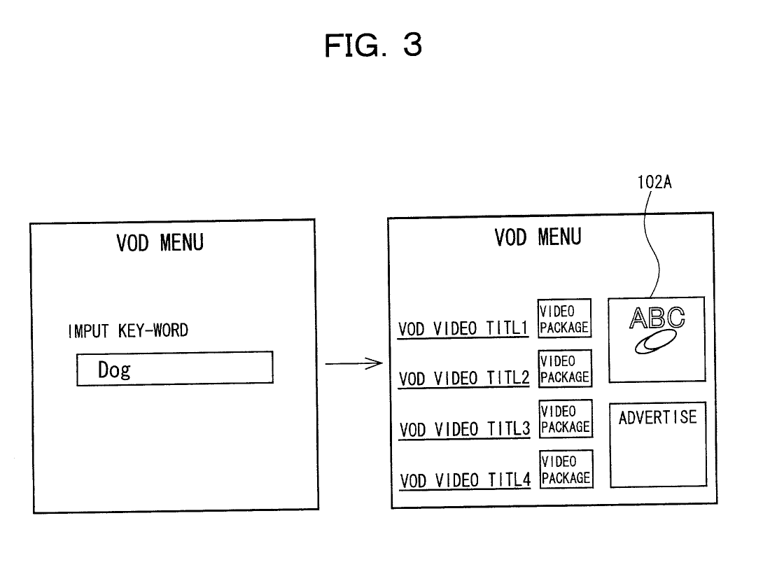

(1) As shown in FIG. 3, a keyword related to a title that is desired to view is input from the VOD menu screen and sent this keyword to the search server 107.

(2) The search server 107 sends a search request for the above-noted keyword to each MPEG7 compatible VOD server 103.

(3) Each VOD server 103 sends search results (the parameters noted below) to the search server 107.

If there is a hit resulted from the video content search, the information sent is the title of the video, the position (IP address or the like) of the VOD at which the video resides, and a static image of the content of the video.

If there was no hit, however, information to that effect is sent.

(4) The search server 107 summarizes the search results from each of the VOD servers 103, formats it for display on the menu screen of the set-top box 102, and sends it to the set-top box 102.

(5) As shown in FIG. 3, because the search results are displayed on the VOD menu screen, the user can specify a desired video therefrom, and send a playback request to the corresponding VOD server 103.

(6) Upon receiving a playback request from the set-top box 102, a VOD server 103 provides the video image to the set-top box 102, after which exchange is conducted with the VOD server for such trick play functions as pause, rewind, and fast forward.

(Second Embodiment)

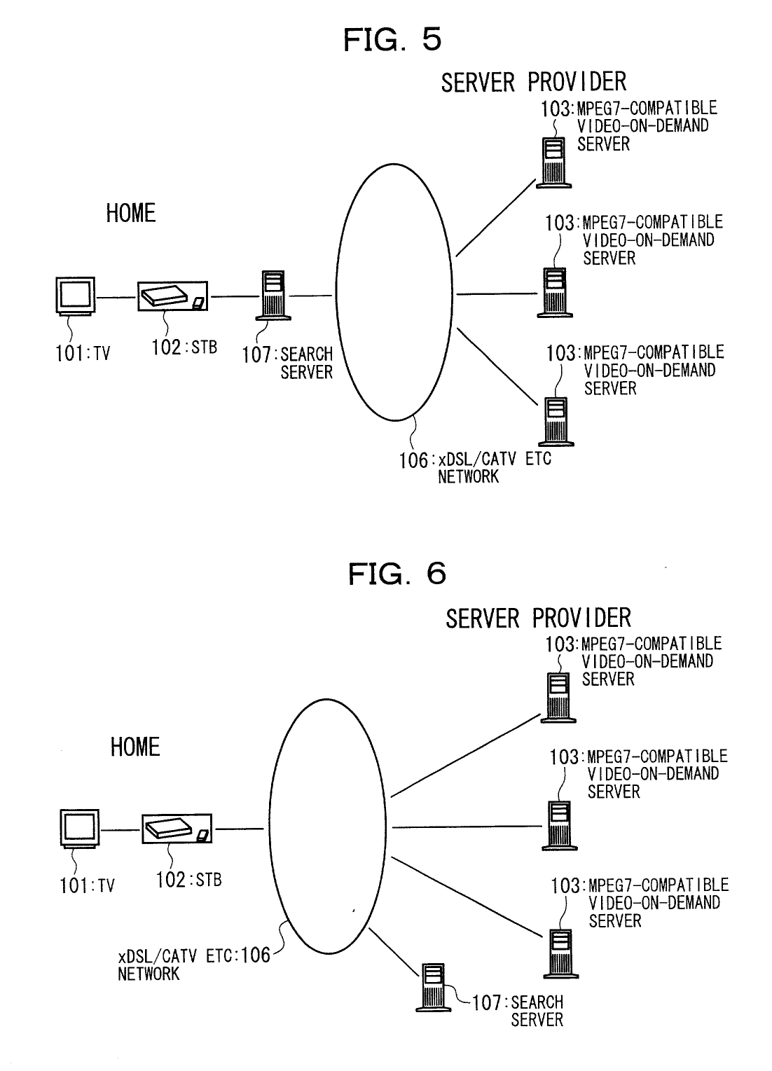

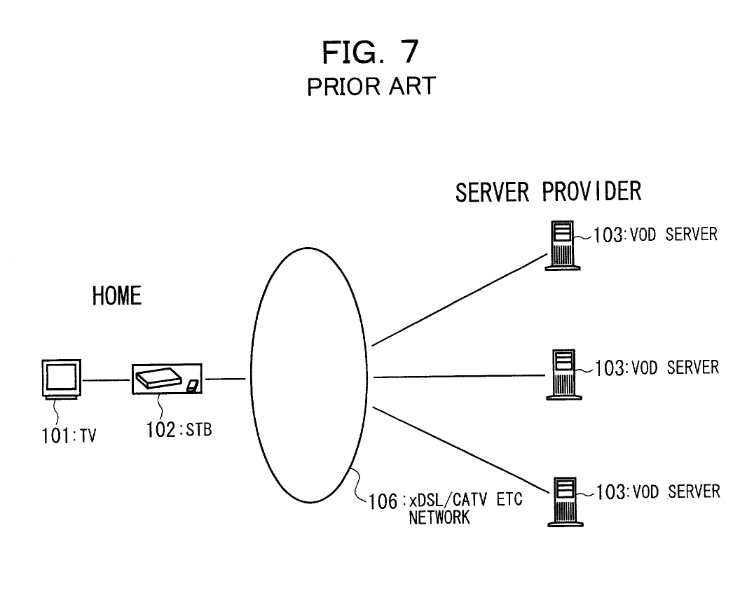

A second embodiment of the present invention is shown in FIG. 5. In the second embodiment, the search server 107 is either installed in a user home or within the set-top box 102.

(Third Embodiment)

A third embodiment of the present invention is shown in FIG. 6. In the third embodiment, the search server 107 is disposed within an xDSL/cable TV network 106, and in this example the cable TV company or the like provides a search service.

As shown in FIG. 3, by running an advertisement 102A as part of the search screen, it is possible for the cable TV company or the like to obtain advertising income.

It is possible for the server 107, in addition to search results, to cause display of advertisements linked to the searched for keyword. More specifically, for example, for the keyword “sports”, a sports-related advertisement (for example, advertisement for a sports drink) could be displayed.

In the above case, it is possible for the server to count the number of times each keyword is specified, and to increase the advertising fees for advertisements displayed for such high-frequency keywords, or to lower the advertising fees for advertisements displayed for low-frequency keywords.

According to the present invention, it is possible for the user to search for a desired video using a keyword, even if the actual title of the video is unknown. Particularly, the present invention uses free keywords to perform searching, it is possible for anyone to easily find the desired content.

What is claimed is:

1. A video-on-demand system comprising:
a video-on-demand server, connected to a network, for storing a plurality of video content,
a set-top box, connected to said network, for recalling video content stored in said video-on-demand server and viewing said recalled video content, and
a TV picture receiving apparatus connected to said set-top box,
wherein said video-on-demand server having content information indicating characteristic of said plurality of video content stored therein, and
a search server, connected to said network, for searching said content information stored in said video-on-demand server, being provided.

2. The video-on-demand system according to claim 1, wherein said content information is coded in an MPEG7 format.

3. A content searching method in a video-on-demand system comprising:
a video-on-demand server, connected to a network, for storing a plurality of video content,
a set-top box, connected to said network, for recalling video content stored in said video-on-demand server and viewing said recalled video content, and
a TV picture receiving apparatus connected to said set-top box,
wherein said method comprising the steps of:
inputting a keyword from said set-top box, indicating a characteristic of video content that an user desires to view, and sending said keyword to said search server from said set-top box,
searching for said keyword included in said content information stored in said video-on-demand server based on an instruction from said search server,
collecting search results from said video-on-demand server, and
sending said search results from said search server to said set-top box.

4. A computer program for a video-on-demand system comprising:
a video-on-demand server, connected to a network, for storing a plurality of video content,
a set-top box, connected to said network, for recalling video content stored in said video-on-demand server and viewing said recalled video content, and
a TV picture receiving apparatus connected to said set-top box,
said computer program causing a search server to execute the following steps of:
receiving a keyword from said set-top box, indicating a characteristic of video content that an user desires to view,
instructing said video-on-demand server to search for said keyword included in said content information stored in said video-on-demand server,
collecting search results from said video-on-demand server, and
sending said search results from said search server to said set-top box.
